(19) United States
(12) Patent Application Publication
(10) Pub. No.: US 2026/0300649 A1
(43) Pub. Date: Oct. 1, 2026

(54) LANGUAGE MODEL ADAPTATION FOR DOMAIN-FOCUSED TEXT GENERATION

(71) Applicant: Intuit Inc., Mountain View, CA (US)

(72) Inventors: Shai ARDAZI, Petach Tikva (IL); Matan VETZLER, Ramat Gan (IL); Linoy COHEN, Ramat Gan (IL); Udi MENKES, Bat-Yam (IL)

(21) Appl. No.: 19/096,438

(22) Filed: Mar. 31, 2025

(51) Int. Cl. G06F 40/58

(52) U.S. Cl. CPC G06F 40/58

(57) ABSTRACT

Certain aspects of the disclosure provide techniques for language model adaptation to enable domain-focused text generation. A computer-implemented method generally includes processing an input token sequence with a language model to generate raw scores for multiple candidate output tokens; applying a token domain weight to each respective raw score to generate a plurality of weighted raw scores for the candidate output tokens, wherein each token domain weight applied to each respective raw score is based on a frequency of an output token in a corpus of domain-specific data for a first domain; generating, using an activation function, an output probability for each weighted raw score; and generating, with the language model, an output token sequence based on the input token sequence and including a candidate output token associated with a weighted raw score of the plurality of weighted raw scores that is associated with a highest output probability.

### BACKGROUND

### Field

Aspects of the present disclosure relate to domain-focused text generation, such as by a language model.

### Description of Related Art

A long-term goal of artificial intelligence (AI) is to create machines capable of understanding and engaging in conversation with humans using natural language. Dialogue systems, which can communicate with users in natural language, may carry out unstructured conversations, with users, on any topic (e.g., open-domain systems). Performant dialogue systems exhibit competence in understanding natural language, making informed decisions, and generating fluent, engaging, contextually appropriate, and accurate responses.

An example dialogue system may leverage language models, such as large language models (LLMs) and small language models (SLMs), to perform natural language processing (NLP) tasks. A language model is a type of machine learning (ML) model that supports NLP tasks, such as generating text, analyzing sentiments, answering user queries in a conversational manner, translating text from one language to another, and/or the like. Language models make it possible for software to “understand” typical human speech or written content and respond to it by, in some cases, generating human-understandable responses through natural language generation (NLG). An LLM is a type of language model that has a large number of parameters, such a language model with greater than 100 billion parameters (although, it is noted, that the number of parameters generally associated with a simple language model and an LLM may change over time).

A popular LLM model architecture is a generative pre-trained transformer (GPT) model. A GPT model is a specific type of LLM based on a transformer architecture (e.g., architecture that uses an encoder-decoder structure and does not rely on recurrence and/or convolutions to generate an output), that is pre-trained in a generative and unsupervised manner (e.g., it learns from data without being given explicit instructions on what to learn). A GPT model analyzes prompts and predicts the best possible response based on their understanding of the language. In particular, the GPT model may rely on the knowledge it gains after its, in some cases, billions or even trillions of parameters, are trained on massive datasets. As used herein a “prompt,” is a specific instruction and/or request, posed in natural language, given to a computer program and/or language model to perform a particular task and/or generate a specific output.

While language models, such as GPT models, represent a transformative force in many industries by assimilating vast amounts of knowledge, such as to build conversation-driven applications, these models are not without limitation. For example, while a powerful tool, a general-purpose language model (also often referred to as an “off-the-shelf language model”) is only as good as the underlying, publicly available training data used to pre-train the model (e.g., pre-training is the initial phase for training language models). This presents a technical problem in cases where the knowledge artifacts necessary for accurately responding to a prompt are partly, or completely, missing and/or underrepresented in the training data used to train the language model (e.g., such as due to the knowledge artifacts including proprietary data, real-time data, company or industry specific data, specialized technical knowledge, etc.).

For example, training data used to pre-train a language model generally includes publicly available “raw text,” for example, from publicly available books, articles, websites, and/or the like. To be highly capable (e.g., have linguistic and world knowledge), this text may span a wide range of fields, genres, languages, etc. Eventually, training on large amounts of raw text, a language model may learn to encode the structure of language in general (e.g., it learns, that “I like,” for example may be followed by a noun or a participle) as well as the knowledge included in the raw texts that the model was exposed to during training. For example, a language model may learn, that the sentence “George Washington was . . . ” is often followed by the tokens “the first president of the United States,” and hence has a representation of that piece of knowledge, where such knowledge is included in the training data. Raw training text, however, may be selective in the information it includes. Thus, a language model may lack a certain knowledge base that wasn't part of its training data and/or was excluded intentionally from the training data. This limitation may lead to a language model generating incomplete and/or inaccurate responses for one or more topics that are not comprehensively represented in the training data.

### SUMMARY

Certain aspects provide a computer-implemented method of processing an input token sequence with a language model to generate a plurality of raw scores for a plurality of candidate output tokens, each raw score representing a confidence that a candidate output token associated with the raw score represents a next token in the input token sequence; applying a token domain weight to each respective raw score associated with each respective candidate output token of the plurality of candidate output tokens to generate a plurality of weighted raw scores for the plurality of candidate output tokens, wherein each token domain weight applied to each respective raw score is based on a frequency of an output token in a corpus of domain-specific data for a first domain; generating, using an activation function, an output probability for each weighted raw score of the plurality of weighted raw scores for the plurality of candidate output tokens; and generating, with the language model, an output token sequence based on the input token sequence and including a candidate output token associated with a weighted raw score of the plurality of weighted raw scores that is associated with a highest output probability.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example system implementing a language model.

FIG. 2 depicts an example workflow for adapting a language model to generate domain-focused text.

FIG. 3 depicts example domain-focused text generation utilizing token domain weights associated with a particular domain.

FIG. 4 depicts an example method for domain-focused text generation.

FIG. 5 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

As above, although a pre-trained language model is, due to the knowledge it encodes, able to perform a variety of tasks, the model may lack specific knowledge that is not encoded in its training data, such as, for example, domain-specific knowledge. “Domain-specific knowledge” (also referred to as “domain-focused knowledge” and/or simply “domain knowledge”) in ML refers to expertise and understanding of a specific field or subject matter (referred to herein as a “domain”) to which an ML model is applied. Language models may suffer from a domain knowledge deficit where they lack detailed, specialized knowledge for a particular domain, such as finance, healthcare, law, etc. For example, a general-purpose language model pre-trained on publicly-available data may not be able to respond, or may respond incorrectly, to a domain-specific prompt, such as a prompt requesting information about a company's financial statements and/or accounts, a prompt requesting proprietary software code for an application, a prompt requesting information about employee medical records for a previous year, a prompt requesting customer help with an application and/or system internal to a company, and/or the like. The pre-trained language model may not be able to respond, or may respond incorrectly, given the information that is requested is not part of a publicly available training dataset used to pre-train the language model.

To address the shortcomings of language models, some conventional approaches seek to combine and orchestrate language model functionality with other sources of knowledge. For example, some conventional approaches use techniques to “fine-tune” language models for specific domains, such as while also regularly performing updates to their knowledge bases. Fine-tuning language models for specific domains may involve adapting a pre-trained language model to generate domain-focused text (and/or initiate or perform domain-specific tasks). This process allows the language model to better understand and generate content that aligns with a particular field or subject matter of interest.

Some example techniques in fine-tuning may include continual pre-training (CPT) (also referred to as “continued pre-training” or “continuous pre-training”) and/or supervised fine-tuning (SFT). “CPT” refers to the practice of taking a general-purpose language model and progressing the training of the model using new large quantities of unstructured data, such as domain-specific data. The training process may be similar to the one used for the original pre-training of the model. “SFT,” on the other hand, includes fine-tuning a language model (e.g., a general-purpose language model) on a labeled dataset using supervised learning techniques. The pre-trained language model's weights may be adjusted based on gradients derived from task-specific loss, which measures the difference between the language model's predictions and the ground truth labels (e.g., the true and correct labels or outputs associated with the labeled dataset).

Thus, CPT and SFT may be used to update a language model's parameters for a specific domain, while the language model learns the specific domain knowledge, style, terminology, and/or governing principles. CPT and/or SFT beneficially allow for the integration of domain-related knowledge, enhancing the textual representation of concepts and improving learning efficiency of a language model. It should be noted that the above-described fine-tuning techniques are only example strategies that may be used to adapt a pre-trained model for specific domains. In other words, the above-described fine-tuning techniques are not an exhaustive list, and many other techniques may be considered and utilized.

Though fine-tuning techniques, such as CPT and/or SFT, for integrating additional knowledge may be useful for broadening the utility and effectiveness of language models for particular domains, fine-tuning often requires a significant amount of time and compute resources, and, in some cases, may create an inherent latency with respect to deploying updated language models. Furthermore, a technical difficulty associated with fine-tuning involves the preparation of performant fine-tuning data. Specifically, the quality and format of the data used for fine-tuning a language model may play an instrumental role in determining the effectiveness of the resulting model.

Embodiments described herein overcome the aforementioned technical problems and improve upon the state of the art by introducing techniques for adapting a language model to generate domain-focused text. The techniques involve utilizing weighted token generation to apply a token domain weight to each candidate output token (e.g., within a vocabulary of a language model), which may logically represent a next token in an input token sequence. More specifically, weighted token generation may be used to apply a token domain weight to a raw score associated with each candidate output token, where each “raw score” represents a confidence that a candidate output token associated with the raw score represents a next token in an input token sequence. Application of a token domain weight to a raw score associated with a candidate output token may adjust the raw score, thereby adjusting a confidence that the candidate output token represents the next token in the input token sequence. In certain aspects, a larger token domain weight may be applied to a raw score of a candidate output token that is determined to have a higher relevance (or importance) within a particular domain (e.g., thereby indicating key vocabulary and/or terminology that is unique or special to that particular domain) than a candidate output token that has a lower relevance (or importance) within the particular domain. Thus, in some cases, adjusted raw scores of candidate output tokens that are more important or relevant to the particular domain may be greater than adjusted raw scores of candidate output token that are less important or relevant to the particular domain. The language model may determine the probability of each candidate output token representing the next token in the input token sequence based on the adjusted raw scores, such that candidate output tokens associated with larger token domain weights are afforded greater probabilities. A candidate output token having a highest probability may be determined to represent the next token in the input token sequence, and the language model may use this candidate output token to generate an output token sequence. Thus, the output token sequence may include text that is specifically tailored, or “focused,” for the particular domain.

In the context of language models, “tokens” may refer to units of text that the language models process and generate. Tokens may represent individual characters, words, subwords, or even larger linguistic units, depending on the specific tokenization (e.g., segmentation of text into meaningful units to capture its semantic and syntactic structure) approach used. Tokens may act as a bridge between the raw text data and the numerical representations that language models are able to work with. As used herein, a “candidate output token” may refer to a token generated by a language model that represents a potential next token in a text sequence. For example, possible candidate output tokens for the text sequence “The dog is” may include “eating,” “sleeping,” “playing,” and/or “licking.”

As an illustrative example, key terms and phrases associated with a tax domain (e.g., tokens commonly used in the tax domain, which are likely to have a high frequency of appearance in a corpus of tax-domain specific data) may include “taxable income,” “deductions,” “capital gains,” “interest,” and “tax return.” To adapt a language model to produce tax domain-focused text when generating output token(s), such as in response to processing an input token sequence, techniques described herein may assign higher token domain weights to candidate output tokens of the model that include “taxable income,” “deductions,” “capital gains,” “interest,” and/or “tax return.” These token domain weights may be used to adjust a token distribution generated for the candidate output tokens of the model (e.g., all possible tokens in its vocabulary). The token distribution may include raw scores for all tokens in a vocabulary of the language model, where each raw score indicates the language model's prediction of which candidate output token is most likely to logically follow next in the input token sequence (e.g., the token distribution may include [raw score 1 for token 1, raw score 2 for token 2, raw score 3 for token 3, etc.] for all tokens in the language model's vocabulary). For example, the token domain weights may adjust the token distribution such that the probabilities associated with candidate output tokens (e.g., in the language model's vocabulary) of “taxable income,” “deductions,” “capital gains,” “interest,” and/or “tax return” are increased (e.g., when computed). Accordingly, when selecting which token(s) to output in response to processing the input token sequence, the language model may be more likely to select one of the candidate output tokens of “taxable income,” “deductions,” “capital gains,” “interest,” and/or “tax return” given the probabilities associated with these candidate output tokens are adjusted to be higher. Specifically, a higher probability may indicate a higher likelihood that the associated candidate output token represents a next token in the input sequence of tokens, and the language model may be configured to select higher probability token(s) for output.

This example adaptation may be useful for a language model implemented via a tax information service, such as TurboTax® (and its variants) made commercially available by Intuit® of Mountain View, California. For example, the language model may be implemented via TurboTax® to generate responses to taxpayer questions and/or generate tax returns. Techniques described herein may be used to adapt the language model to the tax domain such that the responses and/or tax returns generated by the language model are more likely to comply with current tax laws and/or are contextually accurate and relevant to tax law. In this example, the language model may perform weighted token generation, when generating its responses and/or tax returns, using token domain weights determined based on tax domain data, such as from the United States Tax Code and/or the like.

In certain aspects, the techniques described herein for adapting a language model may be used to adapt a general-purpose language model. Adaptation of the general-purpose language model beneficially helps to improve the model's ability in generating contextually accurate text for a particular domain, while minimizing (or eliminating) the need for costly and time-consuming fine-tuning processes (e.g., such as CPT and/or SFT, among others, described above, which may take approximately one hour up to a few days, depending on the dataset size and model size (i.e., number of parameters)). In certain aspects, the techniques, described herein, for adapting a language model may be utilized to further adapt a language model for a first domain (e.g., finance, healthcare, law, etc.) that has been previously fine-tuned for the first domain. Adaptation of the fine-tuned language model beneficially helps to improve the accuracy and/or relevance of text generated by the language model for the first domain (e.g., two methods of adapting the model, including the techniques described herein in combination with fine-tuning techniques, may be complementary for improving model performance). In certain aspects, the techniques described herein for adapting a language model may be utilized to adapt a language model for a first domain (e.g., finance) that has been previously fine-tuned for a second domain (e.g., law). Adaptation of the previously fine-tuned language model for the first domain beneficially helps to overcome the technical challenges associated with multi-domain fine-tuning. For example, multi-domain fine-tuning of a language model (e.g., fine-tuning a language model for two or more domains) may be more complex than fine-tuning for just one domain, at least due to the model needing to balance tuning of model parameters across multiple domains and learn complex representations, often times with the same memory and computational constraints encountered when performing single-domain fine-tuning. The techniques described herein provide an alternative method, which may enable a language model to generate text tailored to more than one domain, while at least reducing the cost associated with fine-tuning the model.

Notably, the improved language model adaptation techniques described herein can further improve the function of any existing application that utilizes language models for text generation, and more specifically, a domain-specific application (e.g., such as TurboTax®). For example, the techniques may be used to improve the speed, accuracy, and relevance of text generated by these language models, which may in turn improve the overall performance of the application and allow for improved user experience with respect to the application.

### Example System Implementing a Language Model

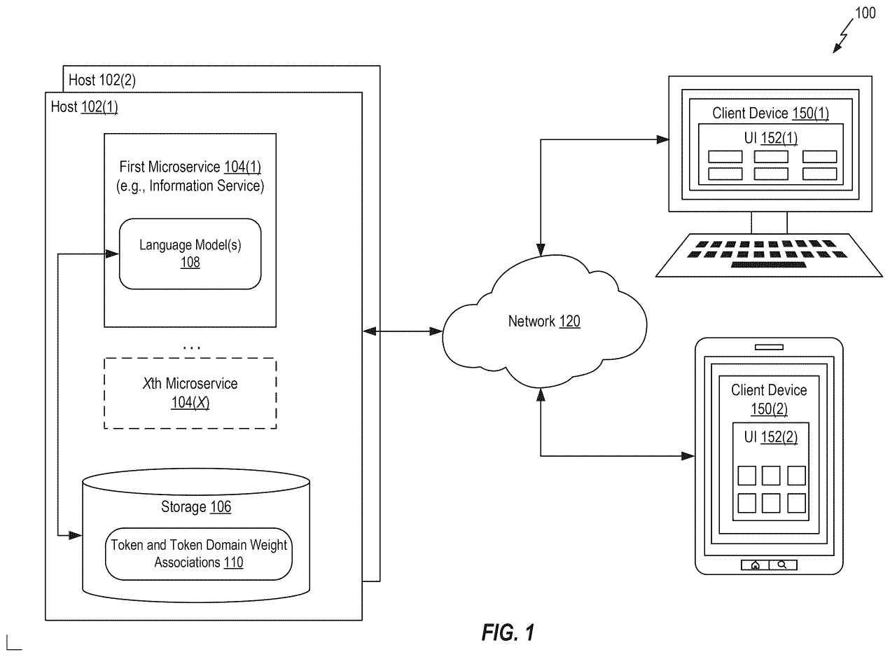

FIG. 1 depicts an example system 100 supporting a plurality of microservices 104 (e.g., software-defined services, which in some cases, may be cloud-native). As shown in FIG. 1, system 100 includes client devices 150(1)-(2) (collectively referred to herein as “client devices 150”) and hosts 102(1)-(2) (collectively referred to herein as “hosts 102”) interconnected through a network 120. Network 120 may be, for example, a direct link, a local area network (LAN), a wide area network (WAN), such as the Internet, another type of network, or a combination of one or more of these networks.

Host 102 may be geographically co-located servers on the same rack or on different racks in any arbitrary location in a data center. Host 102 may be constructed on a server grade hardware platform and include components of a computing device such as, one or more processors (central processing units (CPUs)), one or more memories (random access memory (RAM)), one or more network interfaces (e.g., physical network interfaces (PNICs)), storage 106, and other components (e.g., only storage 106 is shown in FIG. 1).

A first host 102(1) in system 100 may host a plurality of microservices 104(1)-(X) (collectively referred to herein as “microservices 104”), where X is an integer greater than one. The microservices 104 may be deployed using virtual machines (VMs) and/or container(s) running on first host 102(1) (e.g., where first host 102(1) is running a hypervisor (not shown) used to abstract processor, memory, storage, and networking resources of first host 102(1)'s hardware platform). Generally, microservices 104 are loosely coupled and independently deployable services (or software) that may make up an application. Microservices 104 may enable segmented, granular level functionalities within a larger system infrastructure.

Client device 150(1) and client device 150(2) may each include a user interface (UI) 152(1), 152(2), respectively, which may be used to communicate with, at least, a first microservice 104(1) and/or another microservice 104, through the X-th microservice 104(X) using the network 120. For example, communication between client devices 150 and a microservice 104 may be facilitated by one or more application programming interfaces (APIs). Examples of client devices 150 may include a smartphone, a personal computer, a tablet, a laptop computer, and/or other devices.

As shown in FIG. 1, in certain aspects, the first microservice 104(1) implements an information service, which is any network 120 accessible service that maintains financial data, medical data, personal identification data, and/or other data types. For example, the information service may include TurboTax®. In certain aspects, the first microservice 104(1) implements one or more language models 108, such as LLMs or SLMs. First microservice 104(1) may implement language model(s) 108 to provide responses to user prompts, including responses such as answers, advice, and/or help with the preparation of documents and/or reports. For example, TurboTax®, an example information service, may utilize a language model 108 to aid users of the application with preparing one or more financial documents. Language model 108 may provide answers to questions asked by a user of the application, prepare and output one or more reports and/or documents for the user, etc.

According to aspects described herein, the language model(s) 108 may be adapted for one or more specific domains. That is, weighted token generation may be used to adjust the token distribution of candidate output tokens (e.g., all tokens within a vocabulary of a language model 108 that is being adapted), for an input token sequence, such that the probabilities of candidate output tokens that are common (e.g., relevant) to the one or more specific domain(s) correspond to higher probabilities than the candidate output tokens that do not. Accordingly, the language model(s) 108, when generating output token(s) in response to the input token sequence, may be more likely to generate, for output (e.g., via UI 152(1) and/or UI 152(2)) the candidate output token(s) common to the one or more specific domains. For example, the language model(s) 108 may rely on the probability associated with each candidate output token when determining which candidate output token(s) to generate for output. The higher the probability is for a candidate output token, the more likely the language model(s) 108 may be to select this candidate output token for output text generation. In other words, the weighted token generation techniques, used for adapting the language model(s) 108, may allow for domain-focused text generation by the language model(s) 108 for the one or more specific domains.

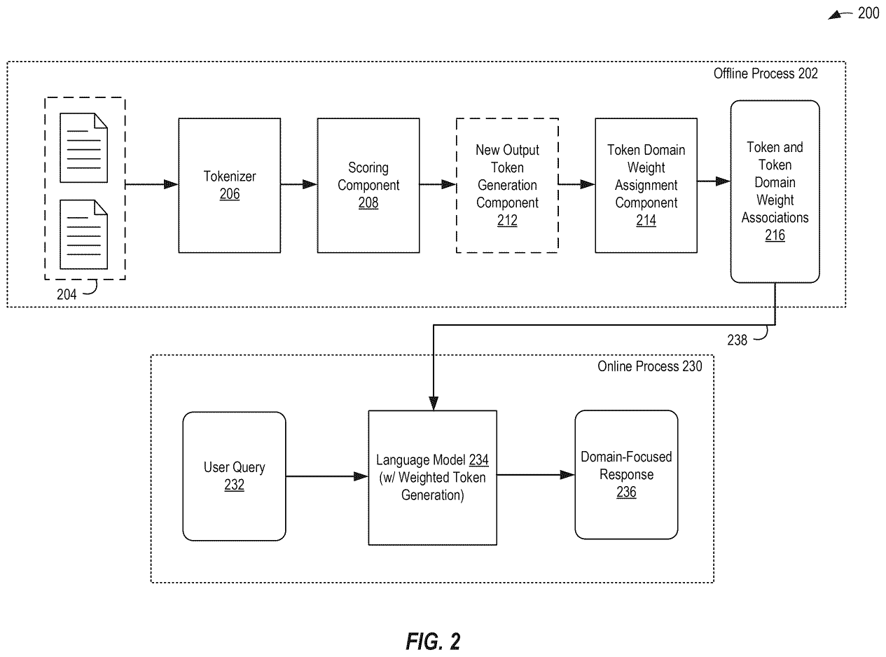

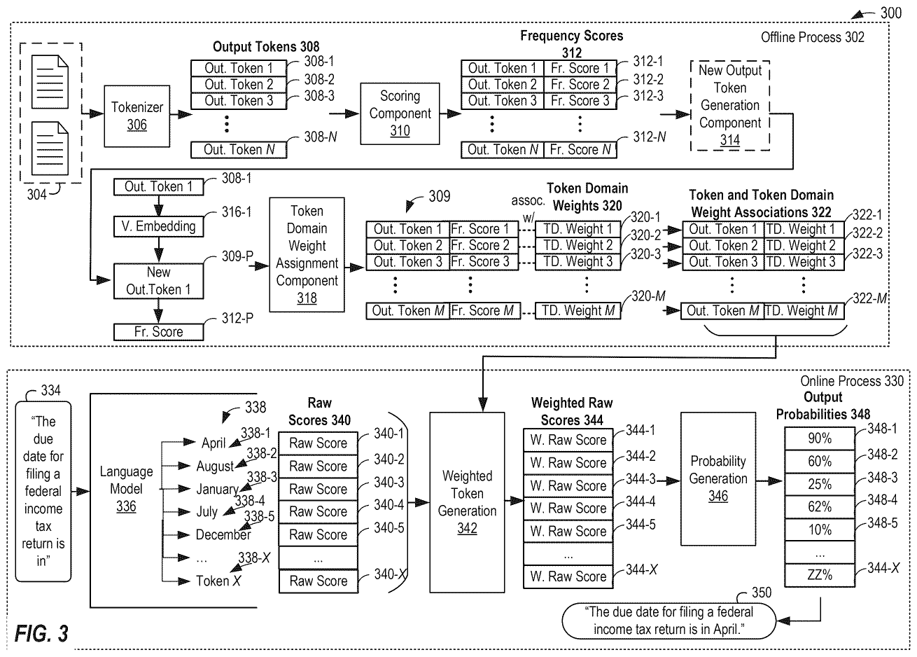

In certain aspects, to perform weighted token generation, language model(s) 108 may use token and token domain weight associations 110, which may be stored in storage 106. For example, prior to the deployment and use of language model(s), such as for real-time query processing, token and token domain weight associations 110 may be generated and stored in storage 106. Additional details related to the generation and use of token and token domain weight associations 110 for weighted token generation (e.g., via language model(s)) are provided below with respect to FIGS. 2 and 3.

Though FIG. 1 depicts each of first host 102(1), storage 106, client device 150(1), and client device 150(2) as single devices for ease of illustration, first host 102(1), storage 106, client device 150(1), and/or client device 150(2) may be embodied in different forms for different implementations. Further, though FIG. 1 depicts only two hosts 102 and two client devices 150, other examples may include more or fewer hosts 102 and/or client devices 150, and client devices 150 may use any combination of microservices 104 on any host 102 where microservices 104 are deployed.

### Example Workflow for Domain-Focused Text Generation Utilizing Token Domain Weights

FIG. 2 depicts an example workflow 200 for adapting a language model 234 to generate domain-focused text. For example, workflow 200 may be used to (1) generate token domain weights for a particular domain (e.g., a first domain, such as a tax domain) and (2) apply these token domain weights to candidate output tokens of the language model 234 (e.g., and more specifically their raw scores generated by language model 234), such as to adjust the respective output probability of each candidate output token. Candidate output tokens of the language model 234 may include tokens in a vocabulary of the language model 234, which may potentially represent a next token in an input token sequence. Adjustment of the output probability associated with each candidate output token may increase the likelihood of a candidate output token that is associated with the first domain being generated by the language model as output (or decrease the output probability associated with each candidate output token that is not associated with the first domain) when processing the input token sequence. As such, the language model may be adapted to generate, for the input token sequence, output text that is “focused” towards the first domain. Put differently, when using workflow 200, the output text generated by the language model may be more contextually accurate and/or relevant for the first domain.

As shown in workflow 200 of FIG. 2, token domain weight generation may be performed as an offline process 202, while application of the token domain weights, such as during weighted token generation by the language model 234, may be performed as an online process 230. As used herein, an “offline process 202” may refer to a task or process that occurs prior to the deployment of the language model 234 for real-time use (e.g., such as for real-time text generation in response one or more queries, such as user query 232 shown in FIG. 2). Further, an “online process 230” may refer to a task or process that occurs subsequent to the deployment of the language model 234. For example, the online process 230 may involve the language model 234 utilizing the token domain weights, generated during the offline process 202, to interact with users and respond to user queries (e.g., user query 232), such as in real-time. In certain aspects, generating the token domain weights, for the first domain, as an offline process 202 may allow for fast adaptation of the language model 234, such that the language model 234 is able to produce first-domain specific responses, for a user, in a reasonable amount of time (e.g., approximately a few minutes up to an hour, depending on the size of the corpus of data used for adaptation of the language model 234 (e.g., such as including less than 100K documents)), thereby improving overall user experience with the language model 234.

Token domain weight generation, performed as the offline process 202, may involve a tokenizer 206, a scoring component 208, optionally a new output token generation component 212, and a token domain weight assignment component 214. In particular, to generate token domain weights for the first domain, workflow 200 begins with tokenizer 206 tokenizing a corpus of first domain-specific data 204 to obtain a plurality of output tokens. Put differently, tokenizer 206 may break (e.g., partition) the text of the corpus of first domain-specific data into smaller pieces, referred to herein as “output tokens.” An example output token generated by tokenizer 206 may include a word, a sub-word, a phrase, etc. that conveys a particular idea or concept within the larger corpus of first domain-specific data 204. The number and/or diversity of example output tokens generated by tokenizer 206 may vary depending on the complexity and content of the corpus of first domain-specific data 204, as well as the specific tokenization (e.g., segmentation of text into meaningful units to capture its semantic and syntactic structure) approach used to perform the partitioning. The output tokens obtained by tokenizer 206 may make up a pool of output tokens for the first domain.

The corpus of first domain-specific data 204 may include content and/or data that contains information relevant to the first domain. Example domain-specific data may include textual document(s), such as article(s), research paper(s), report(s); structured data, such as database(s), spreadsheet(s), and/or software code; web page(s) or web content; social media post(s) and/or social media comment(s); product description(s) and/or a technical specification(s); legal document(s); educational material and/or course content; a news article; a press release; a customer review and/or feedback; image data; audio data; video data; and/or other structured and/or unstructured data that is relevant to the first domain. The corpus of first domain-specific data 204 may be obtained from one or more knowledge sources, such as device(s), sensor(s), database(s), storage system(s), etc. In certain aspects, a corpus of first domain-specific data 204 is obtained from an information repository (not shown in FIG. 2) implemented using one or more storage devices, such as hard disk drives, solid-state drives, and/or cloud-based storage systems (e.g., such as storage 106 in FIG. 1).

Although FIG. 2 shows the corpus of first domain-specific data 204 comprising two data items (e.g., two documents), it is noted that the corpus of first domain-specific data 204 may include any number and/or type of content and/or data that contains information relevant to the first domain.

The offline process 202 of workflow 200 then proceeds with scoring component 208 assigning a frequency score to each output token generated by tokenizer 206. The frequency score assigned to an output token may be based on a frequency of the output token in the corpus of first domain-specific data 204. Specifically, a higher frequency score may be assigned to an output token that appears more frequently in the corpus of first domain-specific data 204 than another output token that appears less frequently. For example, a first output token “taxable income” may appear 500 times in the corpus of first domain-specific data 204, while a second output token “pediatrician” may appear ten times in the corpus of first domain-specific data 204. Based on the frequency of each of the first output token and the second output token, a higher frequency score may be assigned to the first output token than the second output token.

In certain aspects, the scoring component 208 uses a scoring method, such as term-frequency-inverse document frequency (TF-IDF) (e.g., a statistical measure used in NLP to evaluate the “importance” of a token in a corpus of text, such as relative to other tokens in the corpus of text, or “relevance” of a token in the corpus of text), to assign frequency scores to the output tokens. For example, TF-IDF combines two components: term frequency (TF) and inverse document frequency (IDF). TF may measure how often an output token appears in a document. An output token that appears more frequently in a document (e.g., higher frequency) may suggest greater importance and that the output token is likely relevant to the document's content

$$( e . g . , TF = \frac{Number of times a token appears in a document}{Total number of tokens in the document} ) .$$

IDF, on the other hand, may measure how often the output token appears across all documents in a corpus

$$( e . g . , IDF = log \frac{Total number of documents in a corpus}{Number of documents including the token} ) .$$

In certain aspects, the offline process 202 may then optionally proceed with a new output token generation component 212 generating additional output token(s) (referred to herein as “new output token(s)”). For example, to increase the pool of output tokens obtained from the corpus of first domain-specific data 204 (e.g., generated by tokenizer 206), new output token generation component 212 may generate one or more additional output tokens. Specifically, new output token(s) may be generated based on output token(s) obtained from the corpus of first domain-specific data 204 (e.g., generated by tokenizer 206) with a frequency score (e.g., assigned by scoring component 208) that satisfies a frequency score threshold (e.g., a frequency score of the output token>the frequency score threshold). For example, for an output token with a frequency score satisfying the frequency score threshold, new output token generation component 212 may generate one or more additional output tokens. New output token generation component 212 may generate a new output token by (1) generating a vector embedding (or simply “embedding”) for an output token generated by tokenizer 206 (e.g., which is associated with a frequency score generated by scoring component 208), (2) generating a new output token for the vector embedding, and (3) assigning a frequency score to the new output token. This new output token generated by new output token generation component 212 may be added to the pool of output tokens (e.g., including output tokens obtained from the corpus of first domain-specific data 204). As used herein, “embedding” refers to a technique by which text is given a numerical representation in a vector space (e.g., a lower-dimensional space). Thus, a vector embedding generated for an output token may comprise a numerical representation of the output token, capturing its underlying meaning, inter-word semantics, and/or inter-phrase semantics. In certain aspects, new output token generation component 212 may generate vector embedding(s) and thus new output token(s) to capture semantic relationships within the first domain. In certain aspects, new output token generation component 212 may generate vector embedding(s) and thus new output token(s) to increase the number of output tokens included in the pool of output tokens associated with the first domain.

In certain aspects, the token domain weight assignment component 214 determines a token domain weight that is be associated with each output token in the pool of output tokens (e.g., including output tokens generated by tokenizer 206 and/or output token(s) generated by new output token generation component 212). The token domain weight assignment component 214 may assign token domain weights to the output tokens based on the frequency scores associated with the output tokens. For example, the token domain weight assignment component 214 may assign a first token domain weight to a first output token (e.g., in the pool of output tokens) based on a first frequency score assigned to the first output token. Further, the token domain weight assignment component 214 may assign a second token domain weight to a second output token (e.g., in the pool of output tokens) based on a second frequency score assigned to the second output token. Where first frequency score assigned to the first output token is greater than the second frequency score assigned to the second output token, the first token domain weight may be greater than the second domain weight. Alternatively, where first frequency score assigned to the first output token is less than the second frequency score assigned to the second output token, the first token domain weight may be less than the second domain weight. Accordingly, token domain weight assignment component 214 may generate multiple token and token domain weight associations 216 between (1) the output tokens in the pool of output tokens (e.g., associated with the first domain, which are obtained from the corpus of first domain-specific data 204 and/or generated by new output token generation component 212) and (2) the token domain weights assigned to the output tokens (e.g., a token and token domain weight association 216 may include a 1:1 mapping between an output token and a token domain weight).

As an illustrative example, a first sentence in a first document of the corpus of first domain-specific data 204 may recite “Machine learning is fun and exciting. Further, a second sentence in a second document of the corpus of first domain-specific data 204 may recite “Data science is a growing field.” Using TF-IDF as the scoring method, tokens [machine, learning, is, fun, and, exciting] in the first document may be given TF-IDF scores of [0.44, 0.44, 0.23, 0.44, 0.44, 0.44], and tokens [data, science, is, growing, field] may be given TF-IDF scores of [0.40, 0.51, 0.26, 0.51, 0.51]. Because token “is” appears in both documents, the TF-IDF score for token “is” may be calculated as a mean aggregation. Given the aforementioned TF-IDF scores, for example, a token domain weight assigned to token “data” may be larger than a token domain weight assigned to token “is” because the TF-IDF score for token “data” is greater than the score for token “is.”

As shown via arrow 238 in FIG. 2, the token and token domain weight associations 216 may be used by the language model 234 when responding, such as in real-time, to user queries. For example, language model 234 may use token and token domain weight associations 216 to perform weighted token generation (e.g., as an online process 230) to generate a domain-focused response 236 to a user query 232. For example, the user query 232 may include an input token sequence associated with the first domain, and the language model 234 may utilize token domain weights from the token and token domain weight associations 216 to perform weighted token generation and generate an output token sequence (e.g., as the domain-focused response 236) that is contextually accurate and/or relevant to the first domain.

Additional details related to (1) token domain weight generation (e.g., the offline process 202) and (2) domain-focused response generation (also referred to herein as “domain-focused text generation”) utilizing weighted token generation techniques (e.g., the online process 230) are provided with respect to FIG. 3.

Specifically, FIG. 3 depicts example domain-focused text generation 300, which utilizes token domain weights associated with a first domain. Domain-focused text generation 300 may be used to generate an output token sequence 350 (e.g., including one or more tokens) based on a language model processing an input token sequence 334 (e.g., including one or more tokens) of “The due date for filing your federal income tax return is in.” The output token sequence 350 may be generated using weighted token generation 342 techniques such that the output token sequence 350 generated by the language model 336 includes a contextually accurate response to the input token sequence 334, which includes text tailored to the first domain. In this example, and not meant to be limiting to this example, the first domain may be a tax domain.

For example, in FIG. 3, a language model 336 may be deployed to generate responses to user queries, where the responses include text that is specifically tailored, or “focused,” for the first domain. The language model 336 may perform this response/text generation as an online process 330.

In certain aspects, language model 336 is a general-purpose language model (e.g., no domain-specific fine-tuning). In certain aspects, language model 336 is a language model that has been previously fine-tuned for the first domain. In certain aspects, language model 336 is a language model that has been previously fine-tuned for a second domain (e.g., different than the first domain). In certain aspects, language model 336 comprises an LLM, such as Mistral-7b, Llama3-8b, Falcon-7b, etc.

In this example, language model 336 receives, as input (e.g., such as from a user via a user interface, such as UI 152(1) and/or UI 152(2) in FIG. 1), a user query including input token sequence 334 of “The due date for filing a federal income tax return is in.” The user query may be provided to language model 336 to trigger language model 336 to generate text that answers the user's question asking which month is associated with the deadline for filing a tax return.

Although not shown in FIG. 3, language model 336 may process the input token sequence 334 to partition the input token sequence into twelve tokens of “The,” “due,” “date,” “for,” “filing,” etc. The language model 336 may process these input tokens to build an understanding of the context associated with the input token sequence 334.

To determine a next token in the input token sequence 334 and thereby generate the output token sequence 350, the language model 336 may obtain a plurality of candidate output tokens 338 and their corresponding raw scores 340. The candidate output tokens 338 may include potential next tokens in the input token sequence 334. For example, the candidate output tokens 338 may include “April” (e.g., “April” may logically follow the input token sequence 334 of “The due date for filing a federal income tax return is in”), “August,” “January,” “July,” and “December,” among others not shown in FIG. 3. In certain aspects, the candidate output tokens 338 may include all possible tokens in a vocabulary of language model 336.

Each candidate output token 338 may be associated with a single raw score 340 assigned to each candidate output token 338 by language model 336. The raw score 340 assigned to each candidate output token 338 by language model 336 may indicate a confidence or a prediction by language model 336 that the candidate output token 338 represents a next token in the input token sequence 334. For example, candidate output token 338-1 “April” may be associated with a raw score 340-1, which provides a confidence or a prediction by the language model 336 that candidate output token 338-1 “April” represents the next token in the input token sequence 334. Similarly, candidate output token 338-2 “August” may be associated with a raw score 340-2, candidate output token 338-3 “January” may be associated with a raw score 340-3, candidate output token 338 “July” may be associated with a raw score 340-4, candidate output token 338-5 “December” may be associated with a raw score 340-5, and up to a raw score 340-X for token X 338-X.

To determine which candidate output token 338 to use for generating the output token sequence 350, the language model 336 may perform weighted token generation 342. Weighted token generation 342 may involve language model 336 applying a token domain weight 320 to each candidate output token 338. More specifically, weighted token generation 342 may involve language model 336 applying a specific token domain weight to the raw score 340 associated with each candidate output token 338 to generate multiple weighted raw scores 344. For example, language model 336 may determine a first token domain weight 320 to apply to candidate output token 338-1 “April,” determine a second token domain weight 320 to apply to candidate output token 338-2 “August,” and so on. Language model 336 may apply the first token domain weight 320 to raw score 340-1 to generate weighted raw score 344-1 for candidate output token 338-1, apply the second token domain weight 320 to raw score 340-2 to generate weighted raw score 344-2, and so on. Application of a token domain weight 320 to a raw score 340 may involve multiplying the raw score 340 by the token domain weight 320.

Language model 336 may use token and token domain weight associations 322 (simply “associations 322”) to determine the token domain weight 320 that is to be applied to each raw score 340 associated with each candidate output token 338. For example, to determine a token domain weight that is to be applied to candidate output token 338-1 (e.g., “April”), language model 336 may identify an association 322 that includes an output token 309 that corresponds to (e.g. is the same as, is similar to, matches, etc.) the candidate output token 340-1.

In certain aspects, language model 336 may use cosine similarity techniques to measure the similarity between candidate output token 338-1 (e.g., representing “April”) and each output token 309 of each association 322 (or the cosine similarity between their embeddings). The association 322 that includes an output token 309 with a greatest cosine similarity to the candidate output token 338-1 (e.g., “April”) may be used to determine the token domain weight 320 to apply to the candidate output token 338-1 (e.g., “April”). Alternatively, in certain aspects, language model 336 may measure the similarity between candidate output token 338-1 (e.g., “April”) and each output token 309 of each association 322 (or their embeddings) by calculating Euclidean distances, using a dot product (e.g., for vectors), and/or the like.

In this example, language model 336 may determine that the output token 1 of association 322-1 is most similar to the candidate output token 338-1 (e.g., output token 1 may also include the token “April”). Thus, the language model 336 may apply token domain (TD) weight 1 to the candidate output 338-1 (e.g., multiply the raw score 340-1 for candidate output token 338-1 by the token domain weight 1) to generate weighted raw score 344-1. Similar steps may be used to also generate weighted raw scores 344-1 through 344-X.

In some cases, at least one candidate output token 338 associated with language model 336 may not be found in associations 322. More specifically, none of the output tokens 309 of associations 322 may match the candidate output token 338. For example, a candidate output token 338 may include the token “birthday,” and none of the associations 322 may include an output token 309 of “birthday” or another output token with a similar meaning. In such a case, the token domain weight 320 that is applied to the raw score 340 for the candidate output token (e.g., applied to the raw score 340 for candidate output token 338 “birthday”) may be equal to zero.

Language model 336 then proceeds with performing probability generation 346 to generate an output probability 348 for each weighted raw score 344. For example, probability generation 346 may involve generating an output probability 348-1 for weighted raw score 344-1 (e.g., associated with candidate output token 338-1 “April”), generating an output probability 348-2 for weighted raw score 344-2 (e.g., associated with candidate output token 338-2 “August”), and so on for weighted raw scores 344-3 through 344-X. The output probability 348 generated for each weighted raw score 344 may represent a probability that the candidate output token 338 associated with the respective weighted raw score 344 represents a next token in the input token sequence 334. For example, output probability 348-1 of “90%” indicates that there is a 90% chance that candidate output token 338-1 “April” represents a next token (e.g., an accurate token that is next) in the input token sequence 334 “The due date for filing a federal income tax return is in” such that an output sequence of tokens generated by the language model 336 would read “The due date for filing a federal income tax return is in April.”

In certain aspects, the weighted raw score 344 for each candidate output token 338 may represent a “logit,” or a confidence that the candidate output token 338 associated with the weighted raw score 344 represents a next token in the input token sequence 334. The language model 336 may then apply an activation function to convert the weighted raw score 344 (e.g., logit) for each candidate output token 338 into an output probability 348. In certain aspects, the activation function comprises a SoftMax activation function. Logits may be used herein to represent the raw, unnormalized scores produced by the language model 336. The application of the activation may help to normalize these scores and convert them into probabilities that are more easily understandable, such as to provide a clearer understanding of the language model 336's predictions and associated confidence levels.

Language model 336 then proceeds with generating output token sequence 350 based on the input token sequence 334 and including a candidate output token 338 associated with a weighted raw score 344 that is associated with a highest output probability 348. For example, in FIG. 3, language model 336 generates output tokens sequence 350 based on input token sequence 334 “The due date for filing a federal income tax return is in” and including candidate output token 338-1 “April,” such that output token sequence 350 reads “The due date for filing a federal income tax return is in April.” Language model 336 generates output token sequence 350 including candidate output token 338-1 “April” because the output probability 348-1 associated with the weighted raw score 344-1 for candidate output token 338-1 “April” is the highest output probability among output probabilities 348.

In certain aspects, language model 336 may generate the output token sequence 350 for display, such as display on a user interface for a user that submitted the original query of input token sequence 334.

In certain aspects, the associations 322 used for weighted token generation 342 are generated during an offline process 302, such as before language model 336 is deployed for output token sequence 350 generation. As shown in FIG. 3, the associations 322 may include associations between (1) output tokens 309 and (2) token domain weights 320 (e.g., 1:1 associations), which are generated by a tokenizer 306, a scoring component 310, optionally a new output token generation component 314, and a token domain weight assignment component 318.

For example, as shown in FIG. 3, and similar to the offline process 202 depicted and described above with respect to FIG. 2, tokenizer 306 may obtain a corpus of first domain-specific data 304 and partition the text of the corpus of first domain-specific data 304 into smaller pieces, such as output tokens 308-1 through 308-N (collectively referred to herein as “output tokens 308” and individually referred to herein as “output token 308”), where N is an integer greater than one. Each output token 308 created by tokenizer 306 may include a word, a sub-word, a phrase, etc. that conveys a particular idea or concept within the larger corpus of first domain-specific data 304. For example, output token 308-1 (e.g., “Token 1”) may include a token that appears one or more time in the corpus of first domain-specific data 304, such as the token “April.”

Scoring component 310 then assigns a frequency score 312 to each output token 308. For example, scoring component 310 may generate frequency scores 312-1 through 312-N (collectively referred to herein as “scores 312” and individually referred to herein as “score 312”) for output tokens 308. The frequency score 312 assigned to an output token 308, by scoring component 310, may be based on a frequency of the output token 308 in the corpus of first domain-specific data 304. For example, a higher frequency score 312 may be assigned to an output token 308 that appears more frequently in the corpus of first domain-specific data 304 than another output token 308 that appears less frequently in the corpus of first domain-specific data 304. In certain aspects, the scoring component 310 uses a scoring method, such as TF-IDF (e.g., a statistical measure used in NLP to evaluate the “importance” of a token in a corpus of text, such as relative to other tokens in the corpus of text, or “relevance” of the token in the corpus of text), to assign frequency scores 312 to output tokens 308.

In certain aspects, new output token generation component 314 may then generate one or more new output tokens 309. For example, to increase the pool of output tokens 308 generated by tokenizer 306 from the corpus of first domain-specific data 204 (e.g., generated by tokenizer 206), new output token generation component 212 may generate one or more additional output tokens (e.g., new output token(s) 309). Each new output token 309 that is generated may be generated based on one of the output tokens 308. In certain aspects, new output token generation component 314 may generate a new output token 309 for each output token 308 in a subset of the output tokens 308 (e.g., less than all output tokens 308). For example, new output token generation component 212 may generate one or more new output tokens 309 for each output token 308 assigned a frequency score 312 that is above a frequency score threshold, and not generate any output tokens 309 for each output token 308 assigned a frequency score 312 that is below the frequency score threshold. In certain aspects, the frequency score threshold may be set (e.g., based on) the total number of output tokens 308, available compute, and/or available processing time, among other factors.

In certain aspects, new output token generation component 314 may generate a new output token 309, based on an output token 308, using an embedding component. For example, as shown in FIG. 3 for output token 308-1 (e.g., output token 1), new output token generation component 212 may use an embedding component to generate a vector embedding 316-1 for output token 308-1, then generate a new output token 309-P (e.g., where P is an integer greater than zero) based on the vector embedding 316-1, and then assign a frequency score 312-P to the new output token 309-P. The vector embedding 316-1 generated for output token 308-1, by the embedding component, may comprise a numerical representation of the output token 308-1, capturing its underlying meaning, inter-word semantics, and/or inter-phrase semantics. In certain aspects, the embedding component may comprise a Word2Vec system of models (e.g., embedding models).

New output tokens 309 generated by new output token generation component 314 may be combined with output tokens 308 to create a pool of output token 309. In other words, the pool of output tokens 309 may include output tokens generated by tokenizer 306 and/or output token(s) generated by new output token generation component 314. For example, in FIG. 3, output tokens 308-1 through 308-N may be combined with output token(s) 309 generated by new output token generation component 314 to create a pool of output tokens 309, including output token 1 through output token M (e.g., where M is an integer).

Token domain weight assignment component 318 then (1) determines a token domain weight 320 associated with the frequency score 312 generated for each output token 309 (e.g. such as based on pre-determined associations between frequency scores and token domain weights) and (2) associates the determined token domain weight 320 for each output token 309 with its corresponding output token 309, such as to generate associations 322. For example, token domain weight assignment component 318 may determine token domain weights 320-1 through 320-M (collectively referred to herein as “token domain weights 320” and individually referred to herein as “token domain weight 320”) for output tokens 309. Further, token domain weight assignment component may use the token domain weights 320 and output tokens 309 to generate associations 322-1 through 322-M (collectively referred to herein as “associations 322” and individually referred to herein as “association 322”) for output tokens 308.

In certain aspects, the token domain weight 320 of an association 322 that is associated with an output token 309 commonly found (e.g., indicating high relevance) in the corpus of first domain-specific data 304 (e.g., a “key token” or a “key term”) may be high. Alternatively, the token domain weight 320 of an association 322 that is associated with an output token 309 not commonly found (e.g., indicating low relevance) in the corpus of first domain-specific data 304 may be low. These high and low token domain weights 320 may be used to adjust the candidate output token raw scores 340 (e.g., generated by language model 336), such that candidate output tokens 338 that are “key tokens” or “key terms” in the first domain are likely to receive higher output probabilities 348. The higher output probabilities 348 may help result in these candidate output tokens 338 (e.g., these “key tokens” or “key terms”) being generated for output by language model 336.

### Example Method for Domain-Focused Text Generation

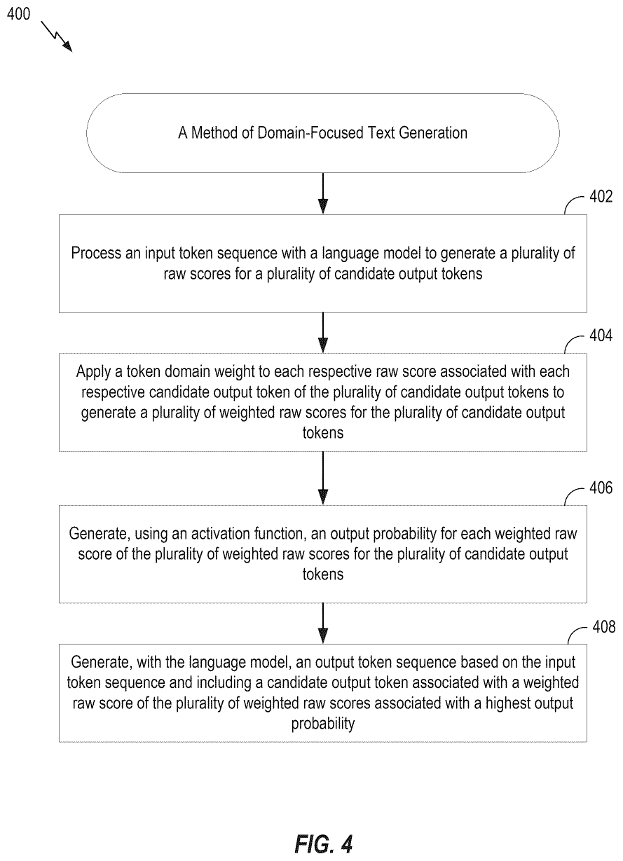

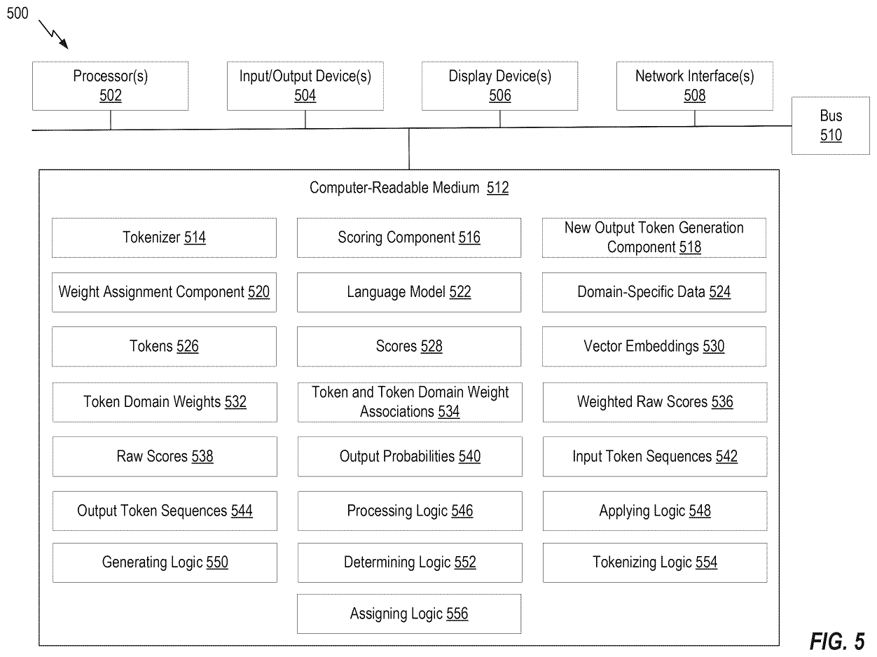

FIG. 4 depicts an example method 400 for domain-focused text generation. In one embodiment, method 400 can be implemented by the system 100 of FIG. 1 and/or processing system 500 of FIG. 5.

By leveraging method 400, such as for language model adaptation, significant technical advantages over conventional solutions may be achieved. For example, method 400, when utilized, may offer a solution for quickly improving the function of any existing language model with respect to a particular domain. Accordingly, an adapted language model may generate text tailored for the particular domain, while reducing, or in some cases eliminating, the cost associated with fine-tuning the model altogether to perform similar domain-focused text generation.

Method 400 starts at block 402 with processing an input token sequence with a language model to generate a plurality of raw scores for a plurality of candidate output tokens. In certain aspects, each raw score may represent a confidence that a candidate output token associated with the raw score represents a next token in the input token sequence.

Method 400 continues to block 404 with applying a token domain weight to each respective raw score associated with each respective candidate output token of the plurality of candidate output tokens to generate a plurality of weighted raw scores for the plurality of candidate output tokens. In certain aspects, each token domain weight applied to each respective raw score is based on a frequency of an output token in a corpus of domain-specific data for a first domain.

Method 400 continues to block 406 with generating, using an activation function, an output probability for each weighted raw score of the plurality of weighted raw scores for the plurality of candidate output tokens.

Method 400 continues to block 408 with generating, with the language model, an output token sequence based on the input token sequence and including a candidate output token associated with a weighted raw score of the plurality of weighted raw scores that is associated with a highest output probability.

In certain aspects, applying the token domain weight to each candidate output token vector embedding of the plurality of candidate output token vector embeddings, at block 404, comprises applying a first token domain weight to a first candidate output token vector embedding of the plurality of candidate output token vector embeddings, the first token domain weight is based on a first frequency of a first output token in the corpus of domain-specific data; and the method further comprises determining the first candidate output token vector embedding corresponds to a first vector embedding that represents the first output token in the corpus of domain-specific data.

In certain aspects, method 400 further includes: tokenizing the corpus of domain-specific data to obtain at least the first output token; generating, via a scoring method, a score indicative of the first frequency of the first output token in the corpus of domain-specific data; generating, via an embedding component, the first vector embedding for the first output token; and assigning the first token domain weight to the first vector embedding based on the score.

In certain aspects, the scoring method comprises a term frequency-inverse document frequency method. In certain aspects, the embedding component comprises a Word2Vec system of models.

In certain aspects, generating, using the activation function, the output probability for each weighted candidate output token vector embedding of the plurality of weighted candidate output token vector embeddings, at block 406, comprises: determining a logit for each weighted candidate output token vector embedding of the plurality of weighted candidate output token vector embeddings, each logit representing a confidence that a candidate output token associated with the weighted candidate output token vector embedding represents a next token in the input token sequence; and applying the activation function to convert the logit for each weighted candidate output token vector embedding into the output probability for each weighted candidate output token vector embedding.

In certain aspects, the language model is: fine-tuned for the first domain; or fine-tuned for a second domain, different from the first domain.

In certain aspects, the first domain comprises a tax domain; the input token sequence is associated with a user query for the tax domain; and the output token sequence represents a response to the user query for the tax domain.

Note that FIG. 4 is just one example of a method, and other methods including fewer, additional, or alternative operations are possible consistent with this disclosure.

### Example Processing System for Domain-Focused Text Generation

FIG. 5 depicts an example processing system 500 configured to perform various aspects described herein, including, for example, method 400 as described above with respect to FIG. 4.

Processing system 500 is generally an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 500 includes one or more processors 502, one or more input/output devices 504, one or more display devices 506, one or more network interfaces 508 through which processing system 500 is connected to one or more networks (e.g., a local network, an intranet, the Internet, or any other group of processing systems communicatively connected to each other), and computer-readable medium 512. In the depicted example, the aforementioned components are coupled by a bus 510, which may generally be configured for data exchange amongst the components. Bus 510 may be representative of multiple buses, while only one is depicted for simplicity.

Processor(s) 502 are generally configured to retrieve and execute instructions stored in one or more memories, including local memories like computer-readable medium 512, as well as remote memories and data stores. Similarly, processor(s) 502 are configured to store application data residing in local memories like the computer-readable medium 512, as well as remote memories and data stores. More generally, bus 510 is configured to transmit programming instructions and application data among the processor(s) 502, display device(s) 506, network interface(s) 508, and/or computer-readable medium 512. In certain embodiments, processor(s) 502 are representative of a one or more central processing units (CPUs), graphics processing unit (GPUs), tensor processing unit (TPUs), accelerators, and other processing devices.

Input/output device(s) 504 may include any device, mechanism, system, interactive display, and/or various other hardware and software components for communicating information between processing system 500 and a user of processing system 500. For example, input/output device(s) 504 may include input hardware, such as a keyboard, touch screen, button, microphone, speaker, and/or other device for receiving inputs from the user and sending outputs to the user.

Display device(s) 506 may generally include any sort of device configured to display data, information, graphics, user interface elements, and the like to a user. For example, display device(s) 506 may include internal and external displays such as an internal display of a tablet computer or an external display for a server computer or a projector. Display device(s) 506 may further include displays for devices, such as augmented, virtual, and/or extended reality devices. In various embodiments, display device(s) 506 may be configured to display a graphical user interface.

Network interface(s) 508 provide processing system 500 with access to external networks and thereby to external processing systems. Network interface(s) 508 can generally be any hardware and/or software capable of transmitting and/or receiving data via a wired or wireless network connection. Accordingly, network interface(s) 508 can include a communication transceiver for sending and/or receiving any wired and/or wireless communication.

Computer-readable medium 512 may be a volatile memory, such as a random access memory (RAM), or a nonvolatile memory, such as nonvolatile random access memory (NVRAM), or the like. In this example, computer-readable medium 512 includes tokenizer 514, scoring component 516, new output generation component 518, weight assignment component 520, language model 522, domain-specific data 524, tokens 526, scores 528, vector embeddings 530, token domain weights 532, token and token domain weight associations 534, weighted raw scores 536, raw scores 538, output probabilities 540, input token sequences 542, output token sequences 544, processing logic 546, applying logic 548, generating logic 550, determining logic 552, tokenizing logic 554, and assigning logic 556.

Note that FIG. 5 is just one example of a processing system consistent with aspects described herein, and other processing systems having additional, alternative, or fewer components are possible consistent with this disclosure.

### EXAMPLE CLAUSES

Implementation examples are described in the following numbered clauses:
Clause 1: A computer-implemented method, comprising: processing an input token sequence with a language model to generate a plurality of raw scores for a plurality of candidate output tokens, each raw score representing a confidence that a candidate output token associated with the raw score represents a next token in the input token sequence; applying a token domain weight to each respective raw score associated with each respective candidate output token of the plurality of candidate output tokens to generate a plurality of weighted raw scores for the plurality of candidate output tokens, wherein each token domain weight applied to each respective raw score is based on a frequency of an output token in a corpus of domain-specific data for a first domain; generating, using an activation function, an output probability for each weighted raw score of the plurality of weighted raw scores for the plurality of candidate output tokens; and generating, with the language model, an output token sequence based on the input token sequence and including a candidate output token associated with a weighted raw score of the plurality of weighted raw scores that is associated with a highest output probability.
Clause 2: The computer-implemented method of Clause 1, wherein: applying the token domain weight to each respective raw score associated with each respective candidate output token of the plurality of candidate output tokens comprises applying a first token domain weight to a first raw score of the plurality of raw scores associated with a first candidate output token of the plurality of candidate output tokens, the first token domain weight is based on a first frequency of a first output token in the corpus of domain-specific data; and the computer-implemented method further comprises determining the first candidate output token corresponds to the first output token in the corpus of domain-specific data.
Clause 3: The computer-implemented method of Clause 2, further comprising: tokenizing the corpus of domain-specific data to obtain at least the first output token; generating, via a scoring method, a first frequency score indicative of the first frequency of the first output token in the corpus of domain-specific data; and assigning the first token domain weight to the first output token based on the first frequency score.
Clause 4: The computer-implemented method of Clause 3, further comprising: based on the first frequency score associated with the first output token satisfying a frequency score threshold, generating, via an embedding component, a vector embedding for the first output token; generating a new output token based on the vector embedding; generating, via the scoring method, a second frequency score for the new output token; and assigning a second token domain weight to the new output token based on the second frequency score.
Clause 5: The computer-implemented method of Clause 4, wherein: the scoring method comprises a term frequency-inverse document frequency (TF-IDF) method; and the embedding component comprises a Word2Vec system of models.
Clause 6: The computer-implemented method of any one of Clauses 1-5, wherein the language model is: fine-tuned for the first domain; or fine-tuned for a second domain, different from the first domain.
Clause 7: The computer-implemented method of any one of Clauses 1-6, wherein: the first domain comprises a tax domain; the input token sequence is associated with a user query for the tax domain; and the output token sequence represents a response to the user query for the tax domain.
Clause 8: A processing system, comprising: a memory comprising computer-executable instructions; and a processor configured to execute the computer-executable instructions and cause the processing system to perform a method in accordance with any one of Clauses 1-7.
Clause 9: A processing system, comprising means for performing a method in accordance with any one of Clauses 1-7.
Clause 10: A non-transitory computer-readable medium storing program code for causing a processing system to perform the steps of any one of Clauses 1-7.
Clause 11: A computer program product embodied on a computer-readable storage medium comprising code for performing a method in accordance with any one of Clauses 1-7.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
processing an input token sequence with a language model to generate a plurality of raw scores for a plurality of candidate output tokens, each raw score representing a confidence that a candidate output token associated with the raw score represents a next token in the input token sequence;
applying a token domain weight to each respective raw score associated with each respective candidate output token of the plurality of candidate output tokens to generate a plurality of weighted raw scores for the plurality of candidate output tokens, wherein each token domain weight applied to each respective raw score is based on a frequency of an output token in a corpus of domain-specific data for a first domain;
generating, using an activation function, an output probability for each weighted raw score of the plurality of weighted raw scores for the plurality of candidate output tokens; and
generating, with the language model, an output token sequence based on the input token sequence and including a candidate output token associated with a weighted raw score of the plurality of weighted raw scores that is associated with a highest output probability.

2. The computer-implemented method of claim 1, wherein:
applying the token domain weight to each respective raw score associated with each respective candidate output token of the plurality of candidate output tokens comprises applying a first token domain weight to a first raw score of the plurality of raw scores associated with a first candidate output token of the plurality of candidate output tokens,
the first token domain weight is based on a first frequency of a first output token in the corpus of domain-specific data; and
the computer-implemented method further comprises determining the first candidate output token corresponds to the first output token in the corpus of domain-specific data.

3. The computer-implemented method of claim 2, further comprising:
tokenizing the corpus of domain-specific data to obtain at least the first output token;
generating, via a scoring method, a first frequency score indicative of the first frequency of the first output token in the corpus of domain-specific data; and
assigning the first token domain weight to the first output token based on the first frequency score.

4. The computer-implemented method of claim 3, further comprising:
based on the first frequency score associated with the first output token satisfying a frequency score threshold, generating, via an embedding component, a vector embedding for the first output token;
generating a new output token based on the vector embedding;
generating, via the scoring method, a second frequency score for the new output token; and
assigning a second token domain weight to the new output token based on the second frequency score.

5. The computer-implemented method of claim 4, wherein:
the scoring method comprises a term frequency-inverse document frequency (TF-IDF) method; and
the embedding component comprises a Word2Vec system of models.

6. The computer-implemented method of claim 1, wherein the language model is:
fine-tuned for the first domain; or
fine-tuned for a second domain, different from the first domain.

7. The computer-implemented method of claim 1, wherein:
the first domain comprises a tax domain;
the input token sequence is associated with a user query for the tax domain; and
the output token sequence represents a response to the user query for the tax domain.

8. A processing system, comprising:
a memory comprising computer-executable instructions; and
a processor configured to execute the computer-executable instructions and cause the processing system to:
process an input token sequence with a language model to generate a plurality of raw scores for a plurality of candidate output tokens, each raw score representing a confidence that a candidate output token associated with the raw score represents a next token in the input token sequence;
apply a token domain weight to each respective raw score associated with each respective candidate output token of the plurality of candidate output tokens to generate a plurality of weighted raw scores for the plurality of candidate output tokens, wherein each token domain weight applied to each respective raw score is based on a frequency of an output token in a corpus of domain-specific data for a first domain;
generate, using an activation function, an output probability for each weighted raw score of the plurality of weighted raw scores for the plurality of candidate output tokens; and
generate, with the language model, an output token sequence based on the input token sequence and including a candidate output token associated with a weighted raw score of the plurality of weighted raw scores that is associated with a highest output probability.

9. The processing system of claim 8, wherein:
to apply the token domain weight to each respective raw score associated with each respective candidate output token of the plurality of candidate output tokens, the processor is configured to execute the computer-executable instructions and cause the processing system to apply a first token domain weight to a first raw score of the plurality of raw scores associated with a first candidate output token of the plurality of candidate output tokens,
the first token domain weight is based on a first frequency of a first output token in the corpus of domain-specific data; and
the processor is further configured to execute the computer-executable instructions and cause the processing system to determine the first candidate output token corresponds to the first output token in the corpus of domain-specific data.

10. The processing system of claim 9, wherein the processor is further configured to execute the computer-executable instructions and cause the processing system to:
tokenize the corpus of domain-specific data to obtain at least the first output token;
generate, via a scoring method, a first frequency score indicative of the first frequency of the first output token in the corpus of domain-specific data; and
assign the first token domain weight to the first output token based on the first frequency score.

11. The processing system of claim 10, wherein the processor is further configured to execute the computer-executable instructions and cause the processing system to:
based on the first frequency score associated with the first output token satisfying a frequency score threshold, generate, via an embedding component, a vector embedding for the first output token;
generate a new output token based on the vector embedding;
generate, via the scoring method, a second frequency score for the new output token; and
assign a second token domain weight to the new output token based on the second frequency score.

12. The processing system of claim 11, wherein:
the scoring method comprises a term frequency-inverse document frequency (TF-IDF) method; and
the embedding component comprises a Word2Vec system of models.

13. The processing system of claim 8, wherein the language model is:
fine-tuned for the first domain; or
fine-tuned for a second domain, different from the first domain.

14. The processing system of claim 8, wherein:
the first domain comprises a tax domain;
the input token sequence is associated with a user query for the tax domain; and
the output token sequence represents a response to the user query for the tax domain.
